(19) United States
(12) Patent Application Publication
(10) Pub. No.: US 2013/0203365 A1
(43) Pub. Date: Aug. 8, 2013

(54) PLUG-IN VEHCILE SECURITY SYSTEM WITH A WIRELESS RELAY

(71) Applicant: CRAIG A. TIEMAN, WESTFIELD, IN (US)

(72) Inventor: CRAIG A. TIEMAN, WESTFIELD, IN (US)

(73) Assignee: DELPHI TECHNOLOGIES, INC., TROY, MI (US)

(21) Appl. No.: 13/365,700

(22) Filed: Feb. 3, 2012

(51) Int. Cl. H04W 88/02

(52) U.S. Cl. 455/90.1

(57) ABSTRACT

A plug-in vehicle security system that includes a plug-in wireless relay module and a plug-in telematics device. The relay module includes a relay switch and a wireless receiver coupled to the relay switch in a manner effective to influence operation of the relay switch based on reception of an authorization signal. The telematics device includes a wireless transmitter configured to transmit the authorization signal in response to a network signal. The telematics device also includes a network transceiver configured to receive the network signal from a communication network. A plug-in vehicle security system is advantageous because installation costs are reduced by reducing the time and installation expertise necessary to do the installation. Such a system will be particularly attractive to vehicle rental fleet operators.

### TECHNICAL FIELD OF INVENTION

This disclosure generally relates to a plug-in vehicle security system, and more particularly relates to a plug-in telematics device that communicates with a wireless communication network and a plug-in wireless relay module equipped with a wireless receiver that operates the relay according to an authorization signal received from the telematics device.

### BACKGROUND OF INVENTION

Vehicle fleet owners that rent vehicles to the general public, or have vehicles shared among multiple authorized drivers (e.g.—employees), have various mechanisms to allow only authorized drivers to gain access to the vehicles and drive them. Installation of these systems generally requires some type of vehicle wiring harness modification (e.g. cutting and splicing of wires) to install electronic devices that prevent unauthorized starting and/or unauthorized operating of a vehicle. Additionally, companies offering aftermarket anti-theft systems may also have remote vehicle disable features to shutdown vehicles, and these systems are also installed by modifying the vehicle wiring harness. Having to modify the vehicle harness to install such security systems is particularly undesirable for vehicle rental fleet operators as such installations require highly skilled personal and tend to take an undesirable amount of time to complete. Furthermore, when the security systems are removed when a vehicle is removed from the fleet, the previous modifications to the wiring harness may compromise the environmental integrity or long-term reliability of the wiring harness potentially leading to electrical problems long after the rental vehicle is sold.

### SUMMARY OF THE INVENTION

In accordance with one embodiment, a plug-in vehicle security system is provided. The system includes a relay module and a telematics device. The relay module is configured for plug-in installation into a vehicle. The relay module includes a relay switch operable to an open-state and a closed-state, and a wireless receiver coupled to the relay switch in a manner effective to influence operation of the relay switch based on reception of an authorization signal. The telematics device is configured for plug-in installation into a vehicle. The telematics device includes a wireless transmitter configured to transmit the authorization signal in response to a network signal. The telematics device also includes a network transceiver configured to receive the network signal from a communication network.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is diagram of a vehicle security system in accordance with one embodiment;

FIG. 2 is a perspective view of a relay module use in the system of FIG. 1 in accordance with one embodiment;

FIG. 3 is a perspective view of a relay module use in the system of FIG. 1 in accordance with one embodiment;

FIG. 4 is a perspective view of a telematics device use in the system of FIG. 1 in accordance with one embodiment;

FIG. 5 is flowchart of a routine executed by the system of FIG. 1 in accordance with one embodiment; and

FIG. 6 is flowchart of a routine executed by the system of FIG. 1 in accordance with one embodiment.

### DETAILED DESCRIPTION

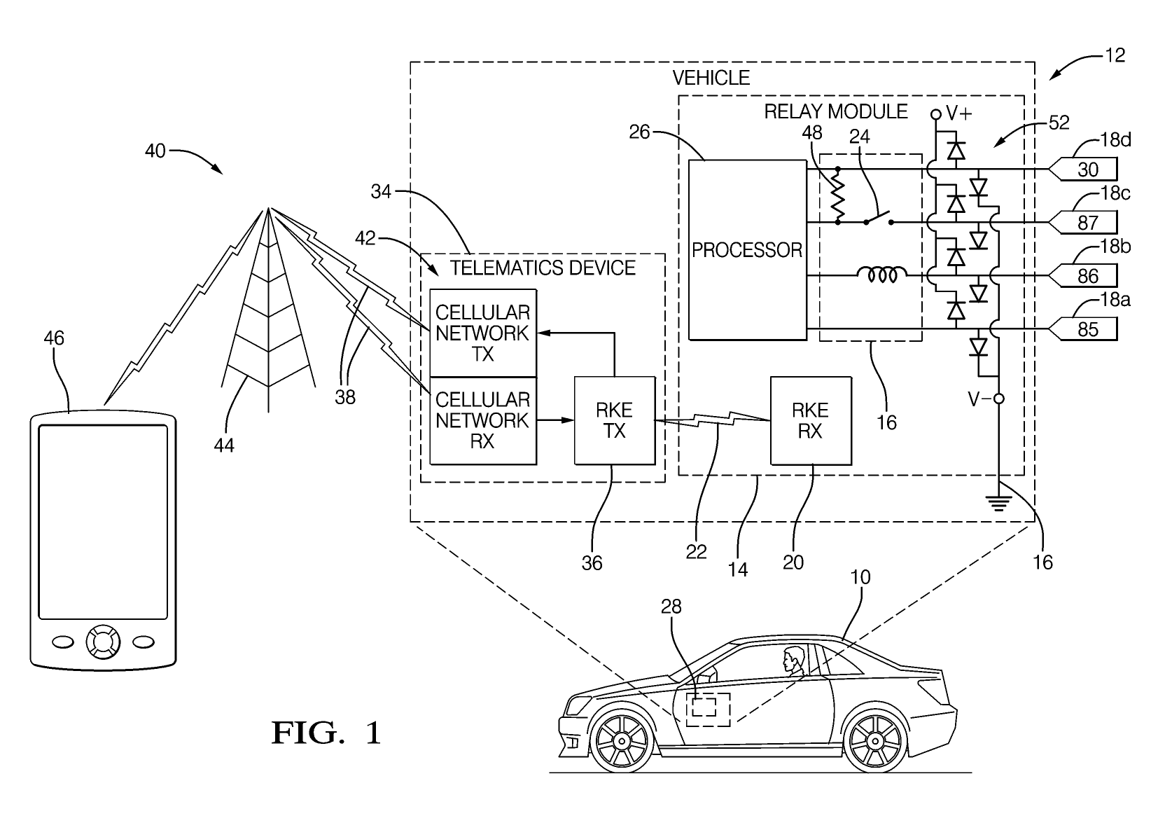

FIG. 1 illustrates a non-limiting example of a vehicle 10 (e.g. an automobile), equipped with a plug-in vehicle security system 12, hereafter often referred to as the system 12. As will become apparent in the description that follows, the system 12 described herein can be installed into the vehicle 10 without cutting or splicing wires of the vehicle wiring harness (not shown) in the vehicle 10 that the system 12 is installed. Such a plug-in vehicle security system will be particularly attractive to vehicle fleet operators, such as vehicle rental fleets, where new vehicles are regularly added to the fleet, and so a vehicle security system must be installed in each new vehicle. Also, when a vehicle is removed from the fleet and sold, the vehicle security system must be removed. By providing a vehicle security system that can be simply plugged into and unplugged from a vehicle, time and installer expertise needed to install the system 12 is reduced, and so fleet operating costs are reduced.

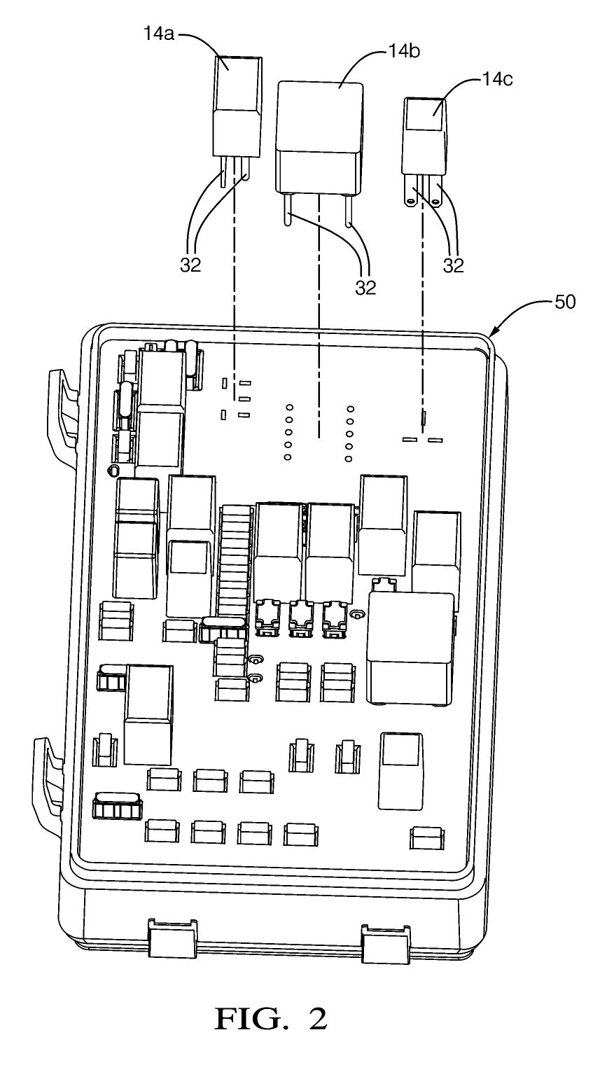

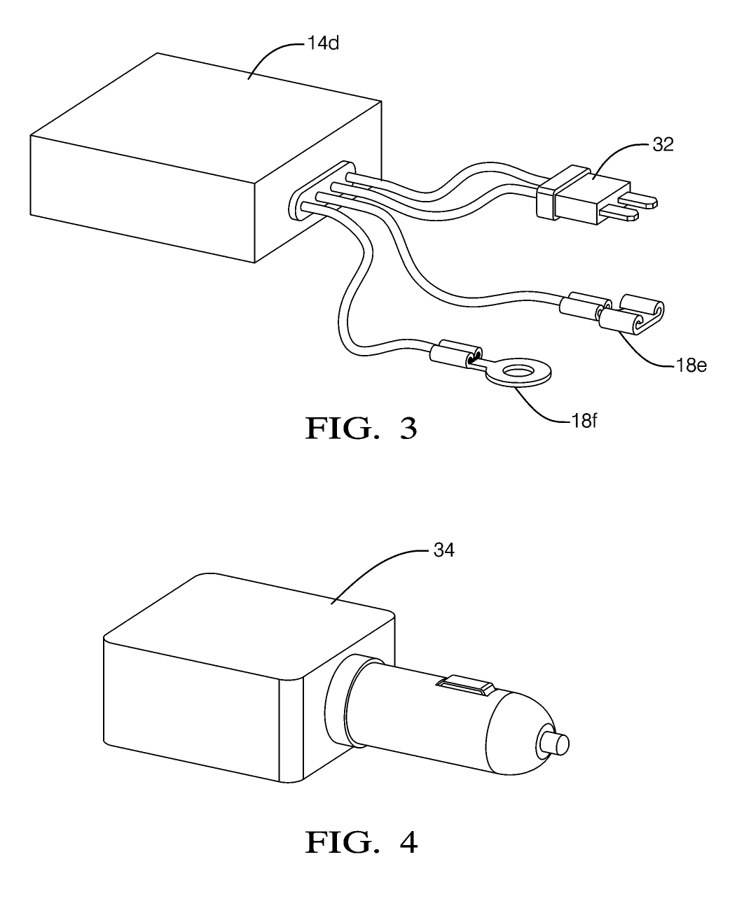

The system 12 may include a wirelessly operated relay module 14 configured for plug-in installation into the vehicle 10. FIGS. 2 and 3 illustrate non-limiting examples of the relay module 14, and these figures will be described in more detail below. The relay module 14 may include a relay switch 16. In general, the relay switch 16 is operable to an open-state and a closed-state by, for example, but not limited to, applying a suitable electrical signal to solenoid connections 18a and 18b. It is noted that solenoid connections 18a and 18b generally correspond to International Organization for Standardization (ISO) relay connection terminals 85 and 86.

The relay module 14 may also include a wireless receiver 20 coupled to the relay switch 16 in a manner effective to influence operation of the relay switch 16 based on reception of an authorization signal 22. The authorization signal is preferably communicated wirelessly, for example by a radio frequency (RF) signal having a carrier frequency of 315 Mega-Hertz (MHz) or 433 MHz which are typically used by vehicle remote keyless entry (RKE) transmitters/receivers. Alternatively, the authorization signal may use other wireless communication protocols such as DASH7®, BLUETOOTH®, or ZIGBEE®.

The wireless receiver 20 may be coupled to the relay switch 16 so that a signal applied to the solenoid connections 18a and 18b is blocked or otherwise prevented from actuating a switch 24 of the relay switch 16. Alternatively, a signal suitable to operate the relay switch 16 may be provided by a processor 26 either operating in cooperation with a signal applied to the solenoid connections 18a and 18b, or independent of a signal applied to the solenoid connections 18a and 18b as will be known to those skilled in the art.

The relay module 14 may include switch connections 18c and 18d that correspond to ISO relay connection terminals 30 and 87. In this example, when the switch 24 is closed, current is able to flow between switch connections 18c and 18d. While the example shown illustrates a single pole single throw type switch, it is contemplated that other configurations are possible, for example, an additional switch connection corresponding to ISO relay connection terminal 87a so the relay module 14 could be used for both normally-open and normally-closed applications.

The processor 26 may include devices such as a microprocessor or other control circuitry as should be evident to those in the art. The processor 26 may include memory (not shown), including non-volatile memory, such as electrically erasable programmable read-only memory (EEPROM) for storing one or more routines, thresholds and captured data. The one or more routines may be executed by the processor 26 to perform steps for operating the relay module 14 as described herein. Electrical power for operating the processor 26 and other electrical devices within the relay module 14 may be drawn from the solenoid connections 18a and 18b and/or switch connections 18c and 18d using diode network 52 to provide voltages V+ and V−, or other known polarity corrections techniques such as those described in U.S. Pat. No. 7,132,762 to Metlitzky et al., issued Nov. 7, 2006, the entire contents of which are hereby incorporated by reference herein. It is recognized that in some vehicle electrical system configurations that an alternative ground connection 54 may be necessary to provide electrical power to the relay module 14, and so a flying lead to a vehicle chassis ground may be necessary.

FIG. 2 illustrates several non-limiting examples of relay modules 14a, 14b, and 14c suitable for installation into an exemplary vehicle power distribution center 50 that is commonly found under-hood in the vehicle engine compartment. The relay modules 14a, 14b, and 14c preferably include plug-in terminals sized and arranged to correspond to a plug-in type automotive relay that the relay modules 14a, 14b, and 14c are to replace. Devices similar to relay modules 14a, 14b, and 14c are available from Master Lock Corporation and are marketed as—MASTER LOCK STARTER SENTRY®. The relay modules may be used to replace any relay in the vehicle 10 suitable for limiting operation of the vehicle 10. Suitable relays for replacement include, but are not limited to, a starter motor relay, a fuel pump relay, an ignition system relay, an electronic transmission relay, and the like. By controlling the operation of relays such as these, the vehicle 10 may be disabled so it cannot be driven by an unauthorized operator.

FIG. 3 illustrates an alternative configuration of a relay module 14d that includes a connector 32 configured to correspond to a plug-in type automotive fuse sometimes referred to as a blade type fuse. It is appreciated that other types of fuses are used in vehicles and it is contemplated that a suitable connector for these other types of fuses will be apparent to those skilled in the art. Preferable, the connector 32 itself does not include a fuse element, but a fuse element (not shown) and a switch (not shown, but similar to switch 24 in FIG. 1) are located within the relay module 14d and are connected in series so that the relay module 14d can be used to prevent or allow current to flow through the fuse element. The relay module 14d may also include power connectors 18e and 18f such as a push-on terminal type connector (18e) for making a plug-in type connection to a typical automotive fuse box 28 (details not shown) or a ring-terminal type connector (180 for making a chassis ground connection in the vehicle 10. It is recognized that the flying leads to the various connectors shown in FIG. 3 could be adapted to make electrical connections between the relay modules 14a, 14b, and 14c shown in FIG. 2 to a typical automotive fuse box and so those relay modules could be used in both direct plug-in applications or adapted to other applications.

Referring again to FIG. 1, the system 12 may also include a telematics device 34 configured for plug-in installation into a vehicle 10. FIG. 4 illustrates a non-limiting example of the telematics device 34 configured for plug-in installation into an automotive 12 Volt accessory plug, a configuration commonly referred to as a cigarette lighter adapter. Alternatively, the telematics device may be packaged in a manner similar to that shown in FIG. 3 so the telematics module 34 can be quickly installed into the vehicle 10 without modifying the wiring harness of the vehicle 10. Also, the telematics device 34 may be configured to be connected to any other vehicle diagnostic connector in the vehicle such as an On-Board Diagnostics II (OBDII) connector, or an Assembly Line Diagnostic Link (ALDL) connector present in some General Motors automobiles. A telematics device configured to plug into a diagnostic connector may be preferable in some instances because the diagnostic connector is often at least partially out of site, and often provides a direct connection to the vehicles internal communication network.

The telematics device 34 may include a wireless transmitter 36 configured to transmit the authorization signal 22 in response to a network signal 38. The network signal 38 may be from a cellular phone network as suggested by FIG. 1, or may be by way of, a WI-FI® network. As such, the telematics device 34 may include a network transceiver 42 configured to receive the network signal 38 from a communication network 44 illustrated in this non-limiting example as a cellular phone tower.

By equipping the system 12 with the network transceiver 42, the authorization signal 22 may be transmitted by the wireless transmitter 36 in response to, for example, a personal communication device 46 such as a smart phone, tablet, or personal computer sending a message via the cellular phone network 40 to the network transceiver 42.

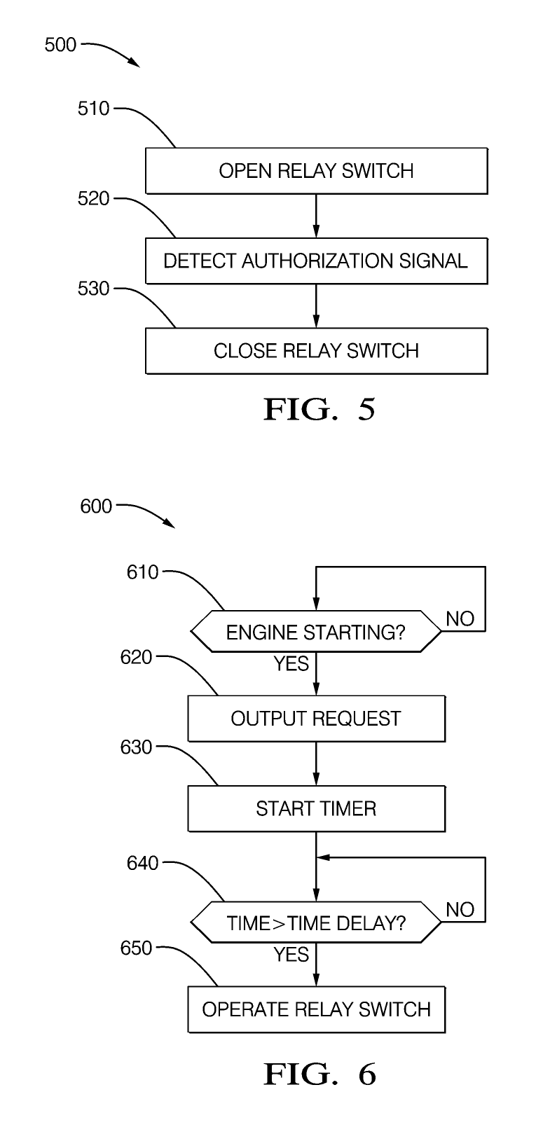

FIG. 5 illustrates a non-limiting example of a routine or flowchart 500 showing steps for operating the relay module 14. Step 510, OPEN RELAY SWITCH, may be a default condition when no power is available to the relay module 14, or may be the result of a command signal from the telematics device 34. For example, the processor 26 may be configured to open-circuit the signal path or current path between the solenoid connections 18a and 18b. Preferably, the switch 24 will remain open until so additional action occurs. Step 520, DETECT AUTHORIZATION SIGNAL, may include the wireless receiver 20 detecting or receiving the authorization signal 22 from the wireless transmitter 36. In response to the authorization signal 22 being received, step 530, CLOSE RELAY SWITCH, may include operating the processor 26 to close-circuit the signal path or current path between the solenoid connections 18a and 18b so the switch 24 can be operated by applying a suitable signal to the solenoid connections 18a and 18b.

FIG. 6 illustrates a non-limiting example of a routine or flowchart 600 showing steps for operating the relay module 14. Step 610, ENGINE STARTING?, may include configuring the processor 26 to determine if the switch 24 or relay module 14 is being operated or used in a manner indicative of an attempt to start an engine (not shown) of the vehicle 10. For example, the processor 26 may monitor voltage levels on the connections 18a, 18b, 18c, and 18d, and determine that an attempt to start the engine has occurred or is indicated if voltage values at one or more of the connections 18a, 18b, 18c, and 18d changes by an amount greater than some predetermined voltage threshold, for example greater than 5 Volts (5V).

Alternatively, the relay module 14 may be configured so one or more currents through the relay module 14 are monitored. For example, the relay module 14 may include a current sense resistor 48, and the processor 26 may be connected to the current sense resistor 48 so the processor 26 is able to determine if current through the switch 24 is greater than a current threshold, for example greater than one Ampere (1 A). If the current through the relay switch and the current sense resistor 48 is greater than the current threshold, that condition may be indicative of an attempt to start an engine of the vehicle. Alternatively, the relay module 14 may be equipped with a current sensor, for example a Hall effect sensor, the operation of which is well known in the art.

By way of a further non-limiting example, if the relay module 14 replaces a fuel pump relay in the vehicle 10, and the current through the current sense resistor 48 corresponds to the amount of current consumed or drawn by the fuel pump (not shown), then that may be an indication that the engine is being started or is running. If the switch 24 in this example is opened by, for example, open-circuiting the signal path between the solenoid connections 18a and 18b, then the vehicle 10 is disabled because no fuel is being pumped to the engine. If there is no evidence of the engine being started (e.g. [ENGINE STARTING?]=NO), the step 610 may be repeated until engine starting is detected. If engine starting is detected (e.g. [ENGINE STARTING?]=YES), then the flowchart 600 proceeds to step 620 or 630 as will be explained below.

Step 620, OUTPUT REQUEST, is an optional step that may be initiated by the processor if an attempt to start the engine is detected, and may include equipping the wireless receiver 20 with a transmitter, equipping the wireless transmitter with a receiver, and transmitting or outputting an authorization request (same signal path indicated by authorization signal 22) in response to determining that the switch 24 is being operated in a manner indicative of an attempt to start the engine. Detecting an attempt to start the engine may be by way of measuring voltages or currents in the relay module as described above.

Step 630, START TIMER, may include equipping or configuring the processor to determine or measure a period of time after an attempt to start the engine, and possible recall from memory a predetermined time delay value.

Step 640, TIME>TIME DELAY?, may include configuring the processor 26 to determine if the period of time is less than or greater than the predetermined time delay, for example one second (1 s). If time has not expired (e.g. [TIME>TIME DELAY?]=NO), then step 640 is repeated. If time has expired (e.g. [TIME>TIME DELAY?]=YES), then the flowchart 600 proceeds to step 650.

Step 650, OPERATE RELAY SWITCH, may include operating the switch 24 in a manner effective to inhibit vehicle operation if either a) the authorization signal 22 is not received following the authorization request or b) the authorization signal 22 is not received in a time period less than the time delay. Operating the switch 24 may include blocking current from a signal applied to the solenoid connections 18a and 18b, or configuring the processor 26 to directly operate the switch 24 to an open state or closed state base on instructions or programming steps stored in the processor 26.

Accordingly, a plug-in vehicle security system 12 is provided. A key advantage of the system 12 describe herein is that the system 12 can be installed into the vehicle 10 quickly and without significant expertise because the relay module 14 and the telematics device 34 are configured to be plugged into features commonly found on most vehicles such as relay sockets or fuse receptacles. Furthermore, the wireless interconnection of the relay module 14 and the telematics device 34 makes the system easy to install and makes a way to defeat the system less apparent to a would-be thief.

While this invention has been described in terms of the preferred embodiments thereof, it is not intended to be so limited, but rather only to the extent set forth in the claims that follow.

We claim:

1. A plug-in vehicle security system comprising:
a relay module configured for plug-in installation into a vehicle, said relay module comprising a relay switch operable to an open-state and a closed-state, and a wireless receiver coupled to the relay switch in a manner effective to influence operation of the relay switch based on reception of an authorization signal; and
a telematics device configured for plug-in installation into a vehicle, said telematics device comprising a wireless transmitter configured to transmit the authorization signal in response to a network signal, said telematics device further comprising a network transceiver configured to receive the network signal from a communication network.

2. The system in accordance with claim 1, wherein the communication network is one of a cellular phone network and a WI-FI® network.

3. The system in accordance with claim 1, wherein the relay module includes plug-in terminals configured to correspond to a plug-in type automotive relay.

4. The system in accordance with claim 1, wherein the relay module includes a connector configured to correspond to an automotive fuse.

5. The system in accordance with claim 1, wherein the relay module is configured so the relay switch is operated to the open-state until an authorization signal is received by the wireless receiver.

6. The system in accordance with claim 1, wherein the relay module further comprises a processor configured to determine if the relay switch is being operated in a manner indicative of an attempt to start an engine of the vehicle.

7. The system in accordance with claim 6, wherein the processor is further configured to determine a time delay in response to determining that the relay switch is being operated in a manner indicative of an attempt to start an engine, and operate the relay switch in a manner effective to inhibit vehicle operation if an authorization signal is not received in a time period less than the time delay.

8. The system in accordance with claim 6, wherein the processor is further configured to output an authorization request in response to determining that the relay switch is being operated in a manner indicative of an attempt to start an engine, and operate the relay switch in a manner effective to inhibit vehicle operation if an authorization signal is not received following the authorization request.

9. The system in accordance with claim 1, wherein the relay module further comprises a processor configured to determine if current through the relay switch is greater than a current threshold, wherein current greater than the current threshold is indicative of an attempt to start an engine of the vehicle.

10. The system in accordance with claim 9, wherein the processor is further configured to determine a time delay in response to determining current greater than the threshold, and operate the relay switch in a manner effective to inhibit vehicle operation if an authorization signal is not received in a time period less than the time delay.

11. The system in accordance with claim 9, wherein the processor is further configured to output an authorization request in response to determining current greater than the current threshold, and operate the relay switch in a manner effective to inhibit vehicle operation if an authorization signal is not received following the authorization request.
